(19) United States
(12) Patent Application Publication
(10) Pub. No.: US 2011/0229693 A1
(43) Pub. Date: Sep. 22, 2011

(54) CONTINUOUS PROCESS FOR MANUFACTURING A SHAPED FOAM ARTICLE

(76) Inventors: Myron Maurer, Saginaw, MI (US); Casey R. Fiting, Freeland, MI (US); Timothy O. Kirch, Midland, MI (US); James J. O'Brien, Midland, MI (US)

(21) Appl. No.: 13/129,831

(22) PCT Filed: Dec. 1, 2009
(86) PCT No.: PCT/US09/66185

§ 371 Date: May 18, 2011

Related U.S. Application Data
(60) Provisional application No. 61/138,302, filed on Dec. 17, 2008.

(51) Int. Cl. B32B 3/30; C08J 9/06

(52) U.S. Cl. 428/159; 264/54

(57) ABSTRACT

The present invention is a method to manufacture shaped foam article. Specifically, the present invention is a method of extruding a styrenic polymer with a blowing agent to form a foam polymer plank having a density gradient and shaping the surface of the foam plank having the lowest density by passing the foam plank through one or more sets of rolls. Preferably, the foam has a vertical compressive balance (Rv) equal to or greater than 0.4 and more preferably, the foam has a cell gas pressure less than 1 atmosphere and/or an open cell content of equal to or less than 20 percent.

### CROSS REFERENCE STATEMENT

This application claims the benefit of U.S. Provisional Application No. 61/138,302, filed Dec. 17, 2008.

### BACKGROUND OF THE INVENTION

The invention relates to an improved continuous method of forming an extruded thermoplastic foam, preferably a polystyrene foam plank, into a shaped foam article.

Extruded thermoplastic foams, for example extruded polystyrene (XPS) foams, have been used for some time in sound and insulation applications. The foams are formed by extruding continuously a heated plastic resin containing a blowing agent through a die, which upon exiting the die expands under, for example, steam or vacuum. Generally, these foams have been limited to applications only requiring simple shapes or complex shapes with a thin thickness. For example, simple shapes include toys that are die cut out of a board that are essentially flat including puzzles and imitation badges. Another approach for shaping foam is to utilize a Computer Numeric Control (CNC) wire saw with an abrasive or multiple hot wires. Hot wires are typically made of nickel chromium. Other more complex shapes, generally, have been made by thermoforming. Thermoforming is a discontinuous operation requiring a mold opening and closing cycle per shaped foam article produced. Furthermore, commercial thermoforming has been limited to shapes using thin XPS sheets such as milk crates. Such methods require pre-heating of the foam so it will take the shape of the mold without fracture or other damage to the foam during the forming process. This method is disadvantaged due to long times necessary to heat and cool the foam and from being a discontinuous molding process.

More complex shapes of polystyrene have, generally, been formed using partially foamed beads of polystyrene that still contain a blowing agent and air diffused therein as a result of aging of the foam from one half to six days. The beads are then placed in a mold and heated sufficiently to expand the beads further such that they full in the mold and weld to each other. Polystyrenes made this way are typically referred to as expanded polystyrene (EPS). Examples of EPS shapes include, coffee cups, cushioned packaging shapes (e.g., shapes that provide cushioning to shipped articles), and bike helmets. This method of forming polystyrene shapes suffers from a complex discontinuous method involving multiple heating and cooling steps and costly molds that need to be heated and cooled.

Other three-dimensional shapes of polystyrene foams have been made by dye cutting flat shapes and laminating them together as described in U.S. Pat. No. 6,129,969. This method suffers from multiple steps to fashion the shaped article.

Finally, polystyrene foam properties have been modified by crushing the foam one or more times. This elasticizing/flexibilization allows for the foam to bounce back after being impacted or bent further without being broken. For extruded foams, the crushing is typically done by roll presses. However, these processes produce only uniformly crushed or compressed foam and not shaped foam articles. Moreover, the final thickness of such foams are often close to the original thickness of the foam prior to compression. Examples of such crushing are described in U.S. Pat. Nos. 3,445,406; 4,510,268; 5,114,656; 5,520,873; and 5,718,968.

Accordingly, it would be desirable to provide a forming method for thermoplastic foam, preferably polystyrene foam, which provides shaped foam articles and in particular thicker shaped foam articles without requiring the foam to be heated prior to and cooled after shaping and/or expensive molds and/or a multi-step or a discontinuous process.

### SUMMARY OF THE INVENTION

The present invention is such a simple, cost effective method to make shaped foam articles. The shaped foam articles of the present invention eliminate the need for complex equipment, multiple molding steps, multiple molds, and heating and cooling the foam thus reducing long cycle times. The method of the present invention can reduce capital, tool complexity, and can allow more flexibility in manufacturing automation and integration.

In one embodiment, the present invention is a method to manufacture a shaped foam article comprising the steps of (i) extruding a thermoplastic polymer with a blowing agent to form a foam polymer plank, the plank having a top and a bottom surface in which said surfaces lie in the plane defined by the direction of extrusion and the width of the plank, wherein the foam plank has (i)(a) a vertical compressive balance equal to or greater than 0.4 and (i)(b) one or more pressing surface and (ii) shaping the pressing surface of the foam plank by a continuous process through one or more sets of rolls wherein one or more roll has a roll face having a defined shape which when pressed into the foam plank provides a shaped foam article with the shape of the roll face. Preferably, the pressing surface is created by the step of (i)(b)(1) removing a layer of foam from (A) the top surface, (B) the bottom surface, or (C) both the top and bottom surfaces or (i)(b)(2) cutting the foam plank between the top and the bottom surfaces creating two pressing surfaces opposite the top and bottom surfaces.

In one embodiment, the thermoplastic foam plank is prepared by extrusion using a chemical blowing agent, an inorganic gas, preferably carbon dioxide, an organic blowing agent, or combinations thereof, wherein the thermoplastic polymer is preferably polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

In one embodiment, the foam has a cell gas pressure equal to or less than 1 atmosphere.

In one embodiment the foam plank is at ambient temperature during the shaping step.

In one embodiment the rolls are heated independently to a temperature between 23° C. to 160° C.

In one embodiment the roll diameters are individually at least four times the thickness of the foam plank.

In one embodiment the present invention is a shaped foam article made by the method described hereinabove, such as siding, an insulation sheathing, a decorative trim, a vinyl siding backing, an integrated radiant floor heating panel, a sandwich panel with non-planer faces, a composite panel, foot wear, a buoyancy part for boats or watercraft, a decoration product for a craft application, an energy absorption component in a helmet, an energy absorption component in a military application, an energy absorption component in an automotive article, or a cushion packaging article.

### BRIEF DESCRIPTION OF THE DRAWINGS

FIG. 1 is an illustration of the step change in the shaped foam article of this invention.

FIG. 2 is a standard cell pressure vs. aging curve for five foamed polystyrene planks.

FIG. 3 is a graphical representation of applied strain versus compressive set for the cut surface of IMPAXX 300 Polystyrene Foam Plank as a function of forming roll diameter.

FIG. 4 is a vertical schematic view of a roll face collar with a defined shape.

FIG. 5 is a vertical schematic of an upper roll having a roll face with a defined shape and lower roll for use in the process of the present invention.

FIG. 5a is a magnification of FIG. 5 wherein a foam is between the upper roll having a roll face with a defined shape and lower roll for use in the process of the present invention.

FIG. 6 is a reproduction of a photograph of a shaped foam article manufactured by the process of the present invention.

FIG. 7 is a graphical representation of the compression set for Examples 15 to 22.

### DETAILED DESCRIPTION OF THE INVENTION

The foamed article of the present invention can be made from any foam composition. A foam composition comprises a continuous matrix material with cells defined therein. Cellular (foam) has the meaning commonly understood in the art in which a polymer has a substantially lowered apparent density comprised of cells that are closed or open. Closed cell means that the gas within that cell is isolated from another cell by the polymer walls forming the cell. Open cell means that the gas in that cell is not so restricted and is able to flow without passing through any polymer cell walls to the atmosphere. The foam article of the present invention can be open or closed celled. A closed cell foam has less than 30 percent, preferably 25 percent or less, more preferably 20 percent or less and still more preferably 10 percent or less and most preferably 5 percent or less open cell content. A closed cell foam can have zero percent open cell content. Conversely, an open cell foam has 30 percent or more, preferably 50 percent or more, still more preferably 70 percent or more, yet more preferably 90 percent or more open cell content. An open cell foam can have 95 percent or more and even 100 percent open cell content. Unless otherwise noted, open cell content is determined according to American Society for Testing and Materials (ASTM) method D6226-05.

Desirably the foam article comprises polymeric foam, which is a foam composition with a polymeric continuous matrix material (polymer matrix material). Any polymeric foam is suitable including extruded polymeric foam, expanded polymeric foam and molded polymeric foam. The polymeric foam can comprise, and desirably comprises as a continuous phase, a thermoplastic or a thermoset polymer matrix material. Desirably, the polymer matrix material has a thermoplastic polymer continuous phase.

A polymeric foam article for use in the present invention can comprise or consist of one or more thermoset polymer, thermoplastic polymer, or combinations or blends thereof. Suitable thermoset polymers include thermoset epoxy foams, phenolic foams, urea-formaldehyde foams, polyurethane foams, and the like.

Suitable thermoplastic polymers include any one or any combination of more than one thermoplastic polymer. Olefinic polymers, alkenyl-aromatic homopolymers and copolymers comprising both olefinic and alkenyl aromatic components are suitable. Examples of suitable olefinic polymers include homopolymers and copolymers of ethylene and propylene (e.g., polyethylene, polypropylene, and copolymers of polyethylene and polypropylene). Alkenyl-aromatic polymers such as polystyrene and polyphenylene oxide/polystyrene blends are particularly suitable polymers for of the foam article o the present invention.

Desirably, the foam article comprises a polymeric foam having a polymer matrix comprising or consisting of one or more than one alkenyl-aromatic polymer. An alkenyl-aromatic polymer is a polymer containing alkenyl aromatic monomers polymerized into the polymer structure. Alkenyl-aromatic polymer can be homopolymers, copolymers or blends of homopolymers and copolymers. Alkenyl-aromatic copolymers can be random copolymers, alternating copolymers, block copolymers, rubber modified, or any combination thereof and my be linear, branched or a mixture thereof.

Styrenic polymers are particularly desirably alkenyl-aromatic polymers. Styrenic polymers have styrene and/or substituted styrene monomer (e.g., alpha methyl styrene) polymerized in the polymer backbone and include both styrene homopolymer, copolymer and blends thereof. Polystyrene and high impact modified polystyrene are two preferred styrenic polymers.

Examples of styrenic copolymers suitable for the present invention include copolymers of styrene with one or more of the following: acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Polystyrene (PS) is a preferred styrenic polymer for use in the foam articles of the present invention because of their good balance between cost and property performance.

Styrene-acrylonitrile copolymer (SAN) is a particularly desirable alkenyl-aromatic polymer for use in the foam articles of the present invention because of its ease of manufacture and monomer availability. SAN copolymer can be a block copolymer or a random copolymer, and can be linear or branched. SAN provides a higher water solubility than polystyrene homopolymer, thereby facilitating use of an aqueous blowing agent. SAN also has higher heat distortion temperature than polystyrene homopolymer, which provides for a foam having a higher use temperature than a polystyrene homopolymer foam. Desirable embodiments of the present process employ polymer compositions that comprise, even consist of SAN. The one or more alkenyl-aromatic polymer, even the polymer composition itself may comprise or consist of a polymer blend of SAN with another polymer such as polystyrene homopolymer.

Whether the polymer composition contains only SAN, or SAN with other polymers, the acrylonitrile (AN) component of the SAN is desirably present at a concentration of 1 weight percent or more, preferably 5 weight percent or more, more preferably 10 weight percent or more based on the weight of all polymers in the polymer composition. The AN component of the SAN is desirably present at a concentration of 50 weight percent or less, typically 30 weight percent or less based on the weight of all polymers in the polymer composition. When AN is present at a concentration of less than 1 weight percent, the water solubility improvement is minimal over polystyrene unless another hydrophilic component is present. When AN is present at a concentration greater than 50 weight percent, the polymer composition tends to suffer from thermal instability while in a melt phase in an extruder.

The styrenic polymer may be of any useful weight average molecular weight (MW). Illustratively, the molecular weight of a styrenic polymer or styrenic copolymer may be from 10,000 to 1,000,000. The molecular weight of a styrenic polymer is desirably less than about 200,000, which surprisingly aids in forming a shaped foam part retaining excellent surface finish and dimensional control. In ascending further preference, the molecular weight of a styrenic polymer or styrenic copolymer is less than about 190,000, 180,000, 175,000, 170,000, 165,000, 160,000, 155,000, 150,000, 145,000, 140,000, 135,000, 130,000, 125,000, 120,000, 115,000, 110,000, 105,000, 100,000, 95,000, and 90,000. For clarity, molecular weight herein is reported as weight average molecular weight unless explicitly stated otherwise. The molecular weight may be determined by any suitable method such as those known in the art.

Rubber modified homopolymers and copolymers of styrenic polymers are preferred styrenic polymers for use in the foam articles of the present invention, particularly when improved impact is desired. Such polymers include the rubber modified homopolymers and copolymers of styrene or alpha-methylstyrene with a copolymerizable comonomer. Preferred comonomers include acrylonitrile which may be employed alone or in combination with other comonomers particularly methylmethacrylate, methacrylonitrile, fumaronitrile and/or an N-arylmaleimide such as N-phenylmaleimide. Highly preferred copolymers contain from about 70 to about 80 percent styrene monomer and 30 to 20 percent acrylonitrile monomer.

Suitable rubbers include the well known homopolymers and copolymers of conjugated dienes, particularly butadiene, as well as other rubbery polymers such as olefin polymers, particularly copolymers of ethylene, propylene and optionally a nonconjugated diene, or acrylate rubbers, particularly homopolymers and copolymers of alkyl acrylates having from 4 to 6 carbons in the alkyl group. In addition, mixtures of the foregoing rubbery polymers may be employed if desired. Preferred rubbers are homopolymers of butadiene and copolymers thereof in an amount equal to or greater than about 5 weight percent, preferably equal to or greater than about 7 weight percent, more preferably equal to or greater than about 10 weight percent and even more preferably equal to or greater than 12 weight percent based on the total weight or the rubber modified styrenic polymer. Preferred rubbers present in an amount equal to or less than about 30 weight percent, preferably equal to or less than about 25 weight percent, more preferably equal to or less than about 20 weight percent and even more preferably equal to or less than 15 weight percent based on the total weight or the rubber modified styrenic polymer. Such rubber copolymers may be random or block copolymers and in addition may be hydrogenated to remove residual unsaturation.

The rubber modified homopolymers or copolymers are preferably prepared by a graft generating process such as by a bulk or solution polymerization or an emulsion polymerization of the copolymer in the presence of the rubbery polymer. Depending on the desired properties of the foam article, the rubbers' particle size may be large (for example greater than 2 micron) or small (for example less than 2 micron) and may be a monomodal average size or multimodal, i.e., mixtures of different size rubber particle sizes, for instance a mixture of large and small rubber particles. In the rubber grafting process various amounts of an ungrafted matrix of the homopolymer or copolymer are also formed. In the solution or bulk polymerization of a rubber modified (co)polymer of a vinyl aromatic monomer, a matrix (co)polymer is formed. The matrix further contains rubber particles having (co)polymer grafted thereto and occluded therein.

High impact poly styrene (HIPS) is a particularly desirable rubber-modified alkenyl-aromatic homopolymer for use in the foam articles of the present invention because of its good blend of cost and performance properties, requiring improved impact strength.

Butadiene, acrylonitrile, and styrene (ABS) terpolymer is a particularly desirable rubber-modified alkenyl-aromatic copolymer for use in the foam articles of the present invention because of its good blend of cost and performance properties, requiring improved impact strength and improved thermal properties.

Foam articles for use in the present invention may be prepared from a foam plank prepared by any known process. A preferred process is an extrusion process wherein a foamable polymer composition of a thermoplastic polymer with a blowing agent is extruded by using an extruder by heating a thermoplastic polymer composition to soften it, mixing a blowing agent composition together with the softened thermoplastic polymer composition at a mixing temperature and mixing pressure that precludes expansion of the blowing agent to any meaningful extent (preferably, that precludes any blowing agent expansion) and then extruding (expelling) the foamable polymer composition through a die into an environment having a temperature and pressure below the mixing temperature and pressure. Upon expelling the foamable polymer composition into the lower pressure the blowing agent expands the thermoplastic polymer into a thermoplastic polymer foam. Desirably, the foamable polymer composition is cooled after mixing and prior to expelling it through the die. In a continuous process, the foamable polymer composition is expelled at an essentially constant rate into the lower pressure to enable essentially continuous foaming wherein the extruded foam plank can be a continuous, seamless foam plank. For example, a method for extruding styrenic foams such as described in U.S. Pat. Nos. 3,231,524; 3,482,006; 4,420,448; and 5,340,844 may be used.

Suitable blowing agents include one or any combination of more than one of the following: inorganic gases such as carbon dioxide, argon, nitrogen, and air; organic blowing agents such as water, aliphatic and cyclic hydrocarbons having from one to nine carbons including methane, ethane, propane, n-butane, isobutane, n-pentane, isopentane, neopentane, cyclobutane, and cyclopentane; fully and partially halogenated alkanes and alkenes having from one to five carbons, preferably that are chlorine-free (e.g., difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc)); fully and partially halogenated polymers and copolymers, desirably fluorinated polymers and copolymers, even more preferably chlorine-free fluorintated polymers and copolymers; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

The amount of blowing agent can be determined by one of ordinary skill in the art without undue experimentation for a given thermoplastic to be foamed based on the type thermoplastic polymer, the type of blowing agent, the shape/configuration of the foam article, and the desired foam density. Generally, the foam article may have a density of from about 16 kilograms per cubic meter (kg/m³) to about 200 kg/m³ or more. The foam density, typically, is selected depending on the particular application. Preferably the foam density is equal to or greater than about 16 kg/m³, more preferably equal to or greater than about 26 kg/m³, and most preferably equal to or greater than about 32 kg/m³. Preferably the foam density is equal to or less than about 160 kg/m³, more preferably equal to or less than about 120 kg/m³, and most preferably equal to or less than about 100 kg/m³. The cells of the foam plank may have an average size (largest dimension) of from about 0.05 to about 5.0 millimeter (mm), especially from about 0.1 to about 3.0 mm, as measured by ASTM D-3576-98. Foam planks having larger average cell sizes, of especially about 1.0 to about 3.0 mm or about 1.0 to about 2.0 mm in the largest dimension, are of particular use when the foam fails to have a compressive balance of at least 0.4 as described in the following paragraph.

The compressive strength of the foam is determined in accordance with industry standard test methods such as ASTM D1621 or modifications thereof. Moreover, the compressive strength of the foam is evaluated in three orthogonal directions, E, V and H, where E is the direction of extrusion, V is the direction of vertical expansion after it exits the extrusion die and H is the direction of horizontal expansion of the foam after it exits the extrusion die. These measured compressive strengths, C_{E}, C_{V} and C_{H}, respectively, are related to the sum of these compressive strengths, C_{T}, such that at least one of C_{E}/C_{T}, Cᵥ/C_{T} and C_{H}/C_{T} (wherein one or more of these terms are referred to collectively as compressive balance), has a value of at least 0.40, preferably a value of at least 0.45 and most preferably a value of at least 0.50. When using such a foam, the pressing direction is desirably parallel to the maximum compressive balance in the foam.

The polymer used to make the foam article of the present invention may contain additives, typically dispersed within the continuous matrix material. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

As per convention, but not limited by, the extrusion of the plank is taken to be horizontally extruded (the direction of extrusion is orthogonal to the direction of gravity). Using such convention, the plank's top surface is that farthest from the ground and the plank's bottom surface is that closest to the ground, with the height of the foam (thickness) being orthogonal to the ground when being extruded.

To facilitate the shape retention and appearance in the shaped foam article after pressing the shaped foam plank, particularly foams comprising closed cells, it is desirable that the average gas pressure is equal to or less than 1.4 atmospheres. In one embodiment, it is desirable that the gas cell pressure is equal to or less than atmospheric pressure to minimize the potential for spring back of the foam after pressing causing less than desirable shape retention. Preferably, the average pressure of the closed cells (i.e., average closed sell cell gas pressure) is equal to or less than 1 atmosphere, preferably equal to or less than 0.95 atmosphere, more preferably equal to or less than 0.90 atmosphere, even more preferably equal to or less than 0.85 atmosphere, and most preferably equal to or less than 0.80 atmosphere.

Unless otherwise noted, cell gas pressures herein are determined from standard cell pressure vs. aging curves, see FIG. 2. Alternatively, cell gas pressure can be determined according to ASTM D7132-05 if the initial time the foam is made is known. If the initial time the foam is made is unknown, then the following alternative empirical method can used: The average internal gas pressure of the closed cells from three samples is determined on cubes of foam measuring approximately 50 mm. One cube is placed in a furnace set to 85° C. under vacuum of at least 1 Torr or less, a second cube is placed in a furnace set to 85° C. at 0.5 atm, and the third cube is placed in the furnace at 85° C. at atmospheric pressure. After 12 hours, each sample is allowed to cool to room temperature in the furnace without changing the pressure in the furnace. After the cube is cool, it is removed from the furnace and the maximum dimensional change in each orthogonal direction is determined. The maximum linear dimensional change is then determined from the measurements and plotted against the pressure and curve fit with a straight line using linear regression analysis with average internal cell pressure being the pressure where the fitted line has zero dimensional change.

After the foam plank is formed, a pressing surface is created 30. If the foam plank has one pressing surface, it is defined as the surface with the lowest density. If the foam plank has two pressing surfaces, then the density of the first and second pressing surface may be the same or different as long as both pressing surfaces have a lower density than the center, or core, of the foam plank. A pressing surface may be formed, for example by removing a layer from the top or bottom surface or cutting the foam plank between the top and bottom surface to create two pressing surfaces opposite the top and bottom surface. Suitable methods that may be useful are cutting using equipment such as band saws, computer numeric controlled (CNC) abrasive wire cutting machines, CNC hot wire cutting equipment, laser cutting, high-pressure fluid cutting, air guns and the like. When removing a layer, the same cutting methods just described may be used and other methods such as planing, grinding or sanding may be used.

Typically, after the removing or cutting, the plank is at least about several millimeters thick to at most about 60 centimeters thick. Generally, when removing a layer, the amount of material is at least about a millimeter and may be any amount useful to perform the method such as 1.2, 1.4, 1.6, 1.8, 2, 2.5, 3, 3.5, 4, 5 millimeters or any subsequent amount determined to be useful such as an amount to remove any skin (i.e., outer surface or top and bottom surface) that is formed as a result of extruding the thermoplastic foam, but is typically no more than 10 millimeters. In another embodiment, the foam is cut and a layer is removed from the top or bottom surface opposite the cut surface to form two pressing surfaces.

In a particular embodiment, the foam plank having a pressing surface 35, has a density gradient from the pressing surface to the opposite surface of the foam plank 34. Generally, it is desirable to have a density gradient of at least 5 percent, 10 percent, 15 percent, 25 percent, 30 percent or even 35 percent from the pressing surface to the opposing surface of the foam plank. To illustrate the density gradient, if the density of the foam at the pressing surface (i.e., within a millimeter or two of the surface) is 3.0 pounds per cubic foot (pcf), the density would be for a 10 percent gradient either 2.7 or 3.3 pcf at the center of the foam. Likewise, if the foam plank has two pressing surfaces (a first pressing surface and a second pressing surface), both surfaces desirably have the aforementioned density gradient, in other words, the core of the foam has a higher density than the two pressing surfaces. Further, the density of the first pressing surface may be the same as the density of the second pressing surface or the density of the first pressing surface may be different than the density of the second pressing surface. In other words, preferably the pressing surface of the foam plank 35 for use in the method of the present invention has a lower density than opposite surface of the plank 34.

The plank prior to contacting with a forming roll may be cut to fit the roll forming equipment. Lastly, the final shaped article may be cut from the pressed part, for example, the foam plank may be roll pressed to form the shape into the pressing surface and subsequently cut. When cutting the foam, any suitable method may be used, such as those known in the art and those described previously for cutting the foam to form a shaped foam article and/or the pressing surfaces. In addition, methods that involve heat may also be used to cut the foam since the pressed shape has already been formed in the pressing surface.

The pressing surface(s) of the plank 35 is contacted with a roll face of the forming roll 40. Herein roll face means any roll having a defined shape that when pressed into the foam plank will cause the foam to take the shape of the roll face 50. That is, the material making up the roll face is such that it does not deform when pressed against the foam plank, but the foam plank deforms to form and retain the desired shape of the roll face.

Typically when pressing, at least a portion of the foam is pressed such that the foam is compressed to a thickness of 95 percent or less of the to be pressed foam thickness (i.e., the original foam blank thickness), which for some foams corresponds to just exceeding the yield stress of the foam. Likewise, when pressing the part, the maximum deformation of the foam (elastically deforming the foam) is typically no more than about 20 percent of the original thickness of the foam ready to be pressed.

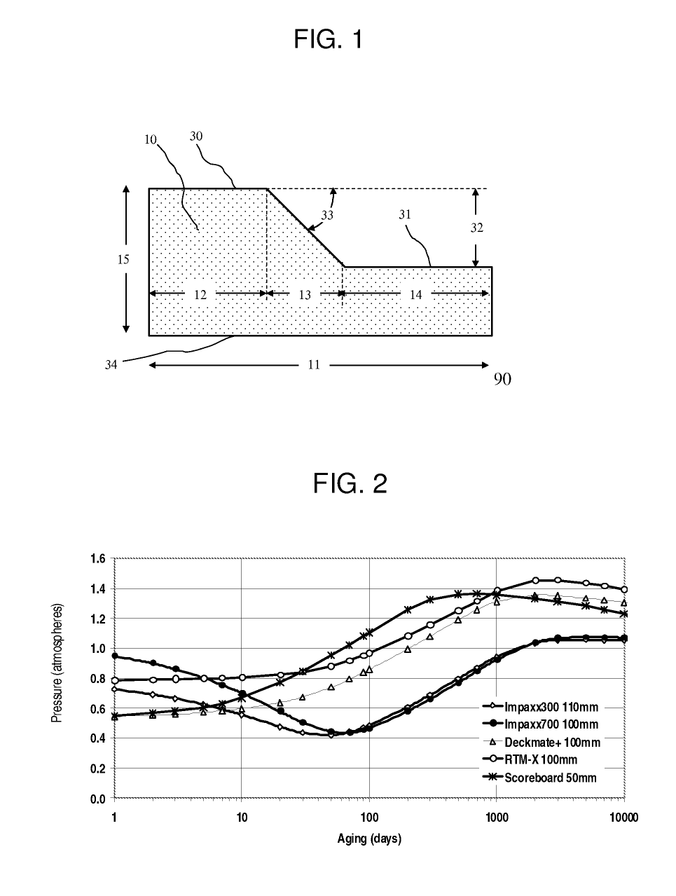

The forming roll face, because a shape is most often desired, typically has contours that create an impression (step change) in height 32 of at least a millimeter in the shaped foam article 10 having thickness 15 as shown in FIG. 1. The height/depth 32 of an impression may be measured using any suitable technique such as contact measurement techniques (e.g., coordinate measuring machines, dial gauges, contour templates) and non-contact techniques such as optical methods including laser methods. The height of the step change 32 may be greater than 1 millimeter such as 1.5, 2, 2.5, 3, 3.5, 4, 5, 6, 7, 8, 9 and 10 millimeters to a height that is to a point where there are no more foam cells to collapse such that pressing further starts to elastically deform the plastic (polymer) of the foam.

The step change, surprisingly, may be formed where the foam undergoes shear. For example, the foam may have a shear angle 33 of about 45° to about 90° from the pressing surface 30 to the pressed surface 31 of the shaped foam article 10 in a step change 32. It is understood that the shear angle may not be linear, but may have some curvature, with the angle in these cases being an average over the curvature. The angle surprisingly may be greater than 60°, 75° or even by 90° while still maintaining an excellent finish and appearance.

In another aspect of the invention, a thermoplastic foam having a higher concentration of open cells at a surface of the foam than the concentration of open cells within the foam is contacted and pressed to form the shape. In this aspect of the invention the foam may be any thermoplastic foam such as the extruded styrenic polymer foam described above. It may also be any other styrenic polymeric foam such as those known in the art.

With respect to this open cell gradient, the gradient is the gradient where the concentration of open cells if determined microscopically and is the number of open cells per total cells at the pressing surface (cut or planed) compared to the number of open cells per total cells at the core of the foam or the other as received surface (i.e., skin surface), whichever comparison (core or other as received surface) provides the greatest gradient value. Preferably, the open cell gradient is equal to or less than 50 percent, more preferably it is equal to or less than 45 percent, more preferably it is equal to or less than 40 percent, more preferably it is equal to or less than 35 percent, more preferably it is equal to or less than 30 percent, more preferably it is equal to or less than 25 percent, more preferably it is equal to or less than 20 percent, more preferably it is equal to or less than 15 percent, more preferably it is equal to or less than 10 percent, or most preferably is equal to 5 percent.

Generally, the amount of open cells in this aspect of the invention at the surface is at least 5 percent to completely open cell. Desirably, the open cells at the surface is at least in ascending order of 6 percent, 7 percent, 8 percent, 10 percent, 20 percent, 30 percent, 40 percent, 50 percent, 60 percent, 70 percent, 80 percent, 90 percent and completely open cell at the surface.

The foam may have the open cells formed at the surface by mechanical means such as those described above (e.g., planing, machining, cutting, etc.) or may be induced chemically, for example, by use of suitable surfactants to burst closed cells at the surface.

The foam surface with the higher concentration of open cells is contacted with a roll face and pressed as described above. In one embodiment for such foams, the roll face(s) may be heated, but the foam is not (ambient 15-30° C.) and the foam plank is pressed. Surprisingly, the heating the roll face(s) results in superior surface contour and appearance, whereas when doing the same with a foam plank without such open cells at the surface, the appearance of the foam is degraded.

Not to be held to any particular theory, we believe that the combination of preferable cell morphology, blowing agent, surface density, and open cell gradient through the foam plank facilitate local buckling when shaping the pressing surface allows for ductile buckling of the cell morphology resulting in the foam to retaining the desired shape with an acceptable (e.g., low) level of compressive recovery.

The shaped foam article may be perforated by any acceptable means. The shaped foam article may have a plurality of perforations. The perforations extend partially through and/or completely through the shaped foam article, for instance for a shaped foam article made from a foam plank, the perforations may extend completely through the depth of the foam plank so as to allow a vacuum to be pulled through the shaped foam article. Perforating the foam article may comprise puncturing the foam article with a one or more of pointed, sharp objects in the nature of a needle, pin, spike, nail, or the like. However, perforating may be accomplished by other means than sharp, pointed objects such as drilling, laser cutting, high-pressure fluid cutting, air guns, projectiles, or the like. The perforations may be made in like manner as disclosed in U.S. Pat. No. 5,424,016, which is hereby incorporated by reference.

The process of the present invention comprises the steps of (i) extruding a thermoplastic polymer with a blowing agent to form a foam polymer plank, the plank having a top and a bottom surface in which said surfaces lie in the plane defined by the direction of extrusion and the width of the plank, wherein the foam plank has a vertical compressive balance equal to or greater than 0.4 and one or more pressing surface and (ii) shaping the one or more pressing surface of the foam plank by a continuous process through one or more sets of rolls wherein one or more roll has a roll face having a defined shape which when pressed into the foam plank provides a shaped foam article with the shape of the roll face.

Either one or both of the rolls may be coated, for example with chrome, polytetrafluoroethane (PTFE, e.g., TEFLON™), a silicone compound (coating or spray applied), or the like.

In the method of the present invention the foam plank may be heated prior to shaping through one or more sets of rolls. Suitable temperatures will depend on the composition of the foam as well as its thickness. Preferably, the foam plank in the present method is shaped at ambient temperature.

When pressing with a heated roll (sometimes referred to as the shaping roll or the embossing roll), the temperature of the roll face is not so hot or in contact with the foam plank for too long a time such that the foam is degraded. Depending on the thermoplastic foam employed, the temperature of the roll face can be from ambient temperature to about 200° C. The temperature is at least about 50° C., preferably at least about 60° C., more preferably at least about 70° C., even more preferably at least about 80° C. and most preferably at least about 90° C. to preferably at most about 190°, more preferably at most about 180°, even more preferably at most about 170° C. and most preferably at most about 160° C. For example, for a styrenic foam the forming roll is preferably at a temperature equal to or greater than 60° C., more preferably equal to or greater than 80° C., and most preferably equal to or greater than 90° C. The temperature of the other roll (guide roll) is preferably equal to or less than 90° C., more preferably equal to or less than 60° C., and most preferably equal to or less than 30° C.

The roll speed will vary depending on the specifics of the foam plank being shaped, for example the composition of the foam, the thickness of the foam plank, the shape being imparted onto the foam plank, etc. Preferably, the roll speed is as fast as possible to provide acceptable shaped foam articles. Preferably the roll speed is equal to or greater than 5 feet per minute (fpm), more preferably equal to or greater than 10 fpm, even more preferably equal to or greater than 25 fpm, and even more preferably equal to or greater than 40 fpm.

The roll diameters, especially the forming roll diameter, is equal to or greater than the thickness of the foam plank. Preferably, the rolls are independently equal to or greater than 2 times the thickness of the foam plank, more preferably 4 times, even more preferably 6 times, even more preferably 8 times, even more preferably 10 times the thickness of the foam plank. The rolls can be even larger than 10 times the thickness of the foam plank, the size of the roll diameter is limited only by any practical limitations of the roll forming equipment.

The roll gap is set such that the gap is less than the thickness of the foam plank. Preferably the gap is set such that the applied strain to compression set ratio is equal to or less than 10, more preferably equal to or less than 2.5, even more preferably equal to or less than 1.5, and even more preferably equal to or less than 1. From a practical stand point, the roll gap should not be set at a thickness that results in a forming pressure on the surface of the foam plank of greater than 1,200 pounds per square inch (psi).

The depth of the shaped feature(s) may be between 2 to 80 percent of the original compressed depth more preferably equal to or greater than 4 percent, more preferably greater than 8 percent and most preferably greater than 10 percent of the original compressed depth.

The shaped foam article of the present invention is a shaped foam article which is prepared from a foamed plank as described hereinabove and further shaped by one or more sets of continuous roll forming and/or embossing rolls to give a shaped foam article. As defined herein, shaped means the foamed article typically has one or more contour that create a step change (impression) in height 32 of at least 1 millimeter or more in the shaped foam article 10 having thickness 15 as shown in FIG. 1. A shaped foam article has at least one surface that is not planar. The shape of the foam article is only limited by the ability to shape foam plank. One or both surfaces (i.e., top and bottom) of the foam plank may be shaped. Examples of shapes are a groove, a corrugation, a sinusoid, or any other three-dimensional surface feature.

Examples of shaped foam articles of the present invention are shaped foam articles for applications such as construction applications: siding, insulation sheathing, decorative trim, vinyl siding backing, integrated radiant floor heating panels, sandwich panels with non-planer faces; furniture applications; composite panels; foot wear; buoyancy parts for boats and watercraft; decoration products for craft applications; energy absorption applications, such as wherein only a portion of the formed article is require for impact energy absorption attenuation, for example an energy absorption component in an automotive articles such as headliner countermeasures, door energy absorbers, bumper inserts, knee bolsters, head rests; helmets; military applications; and crash barriers; etc. Further, the shaped formed articles of the present invention can advantageously be used in packaging applications.

### EXAMPLES

The following foam planks are evaluated:

“IMPAXX™ 300 Foam Plank” is available from The Dow Chemical Co., Midland, Mich. This foam plank is an extruded polystyrene foam with dimensions measuring 110 mm by 600 mm by 2,200 mm in the thickness, width and length directions respectively having a density of 36 kilograms per cubic millimeter (kg/m³) and 5 millimeter (mm) to 7 mm of the surface to be formed is removed by planning. The polystyrene has a weight average molecular weight of 146,000, the blowing agent is CO₂, and the cell gas pressure is about 0.6 atmospheres (atm).

“IMPAXX 500 Foam Plank” is available from The Dow Chemical Co., Midland, Mich. This foam plank is an extruded polystyrene foam with dimensions measuring 110 mm by 600 mm by 2,200 mm in the thickness, width and length directions respectively having a density of 41 kg/m³ and 5 mm to 7 mm of the surface to be formed is removed by planning. The polystyrene has a weight average molecular weight of 146,000, the blowing agent is CO₂, and the cell gas pressure is about 0.8 atm.

“IMPAXX 700 Foam Plank” is available from The Dow Chemical Co., Midland, Mich. This foam plank is an extruded polystyrene foam with dimensions measuring 110 mm by 600 mm by 2,200 mm in the thickness, width and length directions, respectively, having a density of 41 kg/m³ and the surface to be formed contains the skin from the manufacturing process (i.e., not planed). The polystyrene has a weight average molecular weight of 146,000, the blowing agent is CO₂, and the cell gas pressure is about 0.5 atm.

“STYROFOAM™ SCOREBOARD™ Foam Plank” is available from The Dow Chemical Co., Midland, Mich. This foam plank is an extruded polystyrene foam with dimensions measuring 2 in by 48 in by 96 in the thickness, width and length directions, respectively, having a density of 26 kg/m³ and the surface to be formed contains the skin from the manufacturing process (i.e., not planed). The polystyrene has a weight average molecular weight of 168,000, the blowing agent is HCFC-142b, and the cell gas pressure is about 1.3 to 1.4 atm.

“STYROFOAM®-X Foam Plank” is available from The Dow Chemical Co., Midland, Mich. This foam plank is an extruded polystyrene foam with dimensions measuring 100 mm by 600 mm by 2,500 mm in the thickness, width, and length directions, respectively, having a density of 50 kg/m3 and 5 mm to 7 mm of the surface to be formed is removed by planning. The shaped surface further comprises a 2 mm deep groove. The polystyrene has a weight average molecular weight of 200,000, the blowing agent is a mixture of R134A:ethanol:CO2 in a ratio of 6.8:1.7:0.7 parts per hundred (pph), and the cell gas pressure is about 1.3 to 1.4 atm.

“STYROFOAM DECKMATE™ Plus Foam Plank” is available from The Dow Chemical Co., Midland, Mich. This foam plank is an extruded polystyrene foam with dimensions measuring 4 in by 48 in by 96 in the thickness, width and length directions, respectively, having a density of 37 kg/m³ and the surface to be formed contains the skin from the manufacturing process (i.e., not planed). The polystyrene has a weight average molecular weight of 168,000, the blowing agent is HCFC-142b, and the cell gas pressure is about 1.3 to 1.4 atm.

The following properties of the foam planks are summarized in Table 1: “Rv” vertical compressive balance is determined on three replicate tests specimens having a thickness, t (in units of inches), aligned in the vertical (V), horizontal (H) and extrusion (E) direction of the board respectively. Each specimen was compressed at a strain rate, dε/dt, of approximately 0.065 s⁻¹ using a Materials Test System equipped with a 5.0-inch displacement card and a 4,000 pound load card. A 458.91 MicroProfiler was used to program the velocity and displacement of the platens in both loading as well as unloading. For each series of tests, the crosshead velocity, Cv (in units of inches per minute), is determined from the following equation:

$$Cv = 60 \cdot t \cdot \frac{d ɛ}{d t}$$

The crosshead displacement, Δt (in units of inches), is calculated to subject each series of test specimens to a compressive strain of approximately 65 percent as shown in the following equation:

$$Δ t = \frac{ɛ \cdot {t}_{o}}{100}$$

whereby tₒ denotes the original thickness of the test specimen as measured by a linear digital gage. Finally, the return rate (in units of inches per minute) is programmed such that when the crosshead had reached the programmed displacement (i.e. At), the moving platen would unload at the same crosshead velocity during loading.

Prior to testing, the specimen dimensions, in units of inches, are measured in each respective direction (i.e. V, E & H) and the sample mass, M (in units of grams), is recorded using a gravimetric balance. The specimen density, in units of kilograms per cubic meter (kg/m³), is then computed from the following equation:

$$Density = 61.0237 \cdot ( \frac{M}{V \cdot E \cdot H} )$$

The mean density for each foam product is recorded hereinabove.

The compressive strength, CS, of each test specimen is computed in accordance with the procedure detailed in ASTM D1621, “Standard Test Method for Compressive Properties of Rigid Cellular Plastics”. The compressive balance, R, in each direction of the board (i.e. Rv, R_{H} & R_{E}) is computed from the following equations:

R_{V}=CS_{V}/CS_{T}

R_{H}=CS_{H}/CS_{T}

R_{E}=CS_{E}/CS_{T}

whereby CS_{T} denotes the total compressive strength calculated in accordance with the following equation:

CS_{T}=CS_{V}+CS_{H}+CS_{E};

“Density Gradient” is the density profile through the thickness of each foam plank measured using a QMS Density Profiler, model QDP-01X, from Quintek Measurement Systems, Inc. Knoxyille, Tenn. The High Voltage kV Control is set to 90 percent, the High Voltage Current Control was set to 23 percent and the Detector Voltage was approximately 8 volts. Data points are collected every 0.06 mm throughout the thickness of the foam. Mass absorption coefficients were calculated for each sample individually, based on the measured linear density of the foam part being tested. The skin density, ρₛₖᵢₙ, is reported as a maximum value whereas the core density, ρ_{core}, is averaged within an approximate 5 mm range of the center of the plank. The density gradient, in units of percentage, is computed in accordance with the following equation:

$$Density Gradient ( \% ) = 100 \cdot \frac{( {ρ}_{core} - {ρ}_{skin} )}{{ρ}_{skin}}$$

“Open Cell Content” as determined by ASTM D6226 and measured using an Archimedes method on a 25 mm by 25 mm by 50 mm foam sample and the value is reported as mean open cell content in percent; and

“Cell Gas Pressure” is determined from standard cell pressure vs. aging curve, see FIG. 2.

TABLE 1

| | | Density | Open Cell | Cell Gas |
|---|---|---|---|---|
| Example | Rv | Gradient, % | Content, % | Pressure, atm |
| 1-IMPAXX 300 | 0.59 | −18.6 | 4.9 | 0.6 |
| 2-IMPAXX 500 | 0.61 | −38.9 | 4.6 | 0.8 |
| 3-IMPAXX 700 | 0.62 | −53.3 | 2.2 | 0.5 |
| 4-SCOREBOARD | 0.33 | −28.4 | 3.6 | 1.3-1.4 |
| 5- RTM-X | 0.47 | −15.1 | 0.8 | 1.3-1.4 |
| 6-DECKMATE | 0.48 | 32.2 | 3.1 | 1.3-1.4 |

Examples 1 to 12 are foam blank specimens prepared from foam planks and shaped by two roll embossing using embossing roll equipment manufactured by Paratus Industries. The diameter and face of the embossing and guide rolls are 12 inches and 18 inches, respectively. The embossing roll comprises a wood composite grain appearance surface. Each roll is capable of closed loop temperature control and neither roll contained a surface coating (while the embossing rolls are not coated with any type of release material, all the embossing rolls on the Paratus machine are chrome coated steel to improve the longevity of the roll since the primary factor limiting life is abrasive wear). The roll temperatures are intentionally kept low to prevent any foam residue formation on the surface of the rolls. Closed loop control enables the roll speed to be programmed up to a maximum value of approximately 38 feet per minute (fpm). The hydraulic pressure is adjustable between 400-1200 pounds per square inch (psi). The gap between rolls is mechanically adjusted by a series of bolts. A bolt height measurement of approximately 39 mm corresponds to a 0 mm roll gap. Foam blank specimens measuring 300 mm×600 mm×about 45 mm are prepared from the foam planks using a Baumer abrasive wire saw such that each foam blank has a outer (as received-planed or skin depending on the foam) side surface and a cut side surface. Prior to embossing, the original thickness (tₒ) of each foam specimen is measured and recorded using a digital linear gage. Both the lower density surface (“Low ρ”, typically the cut surface) and the higher density surface (“High ρ”, typically the outer/as received surface (e.g., the planed surface for IMPAXX 300 and 500 Foam Planks and the skin surface for SCOREBOARD and IMPAXX 700)) of each type of foam plank is embossed. However, one notable exception is for the DECKMATE Foam Plank, the High ρ surface is the cut surface and the Low ρ surface is the outer/as received surface (as indicated by the positive density gradient value for DECKMATE Foam Plank in Table 1).

The roll gap (dᵣ) is varied to subject foam specimens to compressive applied strain level of 25 percent.

The embossing conditions and results of shaping the foam blanks are presented in Table 2. In Table 2 below:

“Applied Strain” is calculated as follows:

$$Applied Strain ( \% ) = 100 \cdot \frac{( {t}_{o} - {d}_{r} )}{{t}_{o}}$$

and

“Compression Set” is calculated upon completion of shaping the foam blank, the final (i.e., shaped or compressed) blank thickness, t_{f}, is measured using a digital linear gage to compute the induced compression set as follows:

$$Compression Set ( \% ) = 100 \cdot ( \frac{{t}_{o} - {t}_{f}}{{t}_{o}} ) .$$

Examples 13 and 14 are foam blank specimens prepared from IMPAXX 300 Foam Planks. Example 13 is shaped by the Paratus Industries two roll forming equipment described hereinabove.

Example 14 is shaped using a Chemsultants International laboratory bench top laminator (Model HL-1000). The diameters of the embossing and guide rolls are each 4 inches. The top embossing roll is capable of being heated up to 400° F. using a 1500-Watt cartridge heater and subsequently controlled by an Ogden digital temperature controller. The bottom (i.e. drive) guide roll is covered with 80-durometer silicone rubber and the roll speed can vary from 1 to 20 fpm. The forming pressure can be controlled by the use of air regulators that control each side of the embossing roll. The bench top roll former is capable of forming samples up to 18 inches wide.

TABLE 2

| | | Top/Bottom | Applied | Formed | Roll | Compression |
|---|---|---|---|---|---|---|
| Example | Foam Plank | Roll Temps., ° F. | Strain, % | Surface | Speed, fpm | Set, % |
| 1 | IMPAXX 300 | 149/73 | 25 | Cut/ | 38 | 26 |
| | | | | Low ρ | | |
| 2* | IMPAXX 300 | 149/73 | 25 | As received/ | 38 | 25 |
| | | | | High ρ | | |
| 3 | IMPAXX 500 | 149/73 | 25 | Cut/ | 38 | 24 |
| | | | | Low ρ | | |
| 4* | IMPAXX 500 | 149/73 | 25 | As received/ | 38 | 23 |
| | | | | High ρ | | |
| 5 | IMPAXX 700 | 149/73 | 25 | Cut/ | 38 | 18 |
| | | | | Low ρ | | |
| 6* | IMPAXX 700 | 149/73 | 25 | As received/ | 38 | 17 |
| | | | | High ρ | | |
| 7* | SCOREBOARD | 200/73 | 25 | Cut/ | 38 | 4 |
| | | | | Low ρ | | |
| 8* | SCOREBOARD | 200/73 | 25 | As received/ | 38 | 2 |
| | | | | High ρ | | |
| 9 | RTM-X | 162/73 | 25 | Cut/ | 38 | 12 |
| | | | | Low ρ | | |
| 10* | RTM-X | 162/73 | 25 | As received/ | 38 | 9 |
| | | | | High ρ | | |
| 11 | DECKMATE | 143/101 | 25 | As received/ | 38 | 10 |
| | | | | Low ρ | | |
| 12* | DECKMATE | 143/101 | 25 | Cut/ | 38 | 7 |
| | | | | High ρ | | |

*not an example of the invention

Foam blank specimens measuring 300 mm×600 mm×about 45 mm are prepared from IMPAXX 300 foam planks using a Baumer abrasive wire saw such that each foam blank has a outer (as received) side surface and a cut side surface. Prior to forming, the original thickness (tₒ) of each foam specimen is measured and recorded using a digital linear gage. Only the lower density surface for each foam plank is formed. The roll gap (dᵣ) is varied to subject foam specimens to various compressive applied strains ranging from about 3 percent to 90 percent.

The embossing conditions are presented in Table 3.

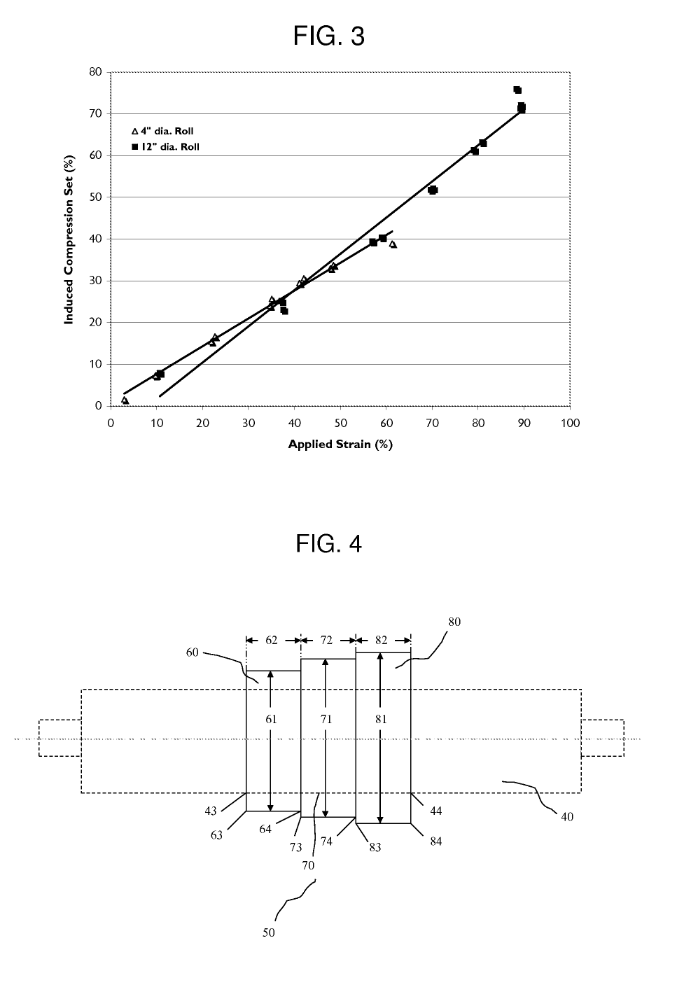

The relationship between applied strain and compressive set for Examples 13 and 14 are presented in Table 4 and graphically represented in FIG. 3.

The roll diameter to foam plank thickness ratio for the 4 inch rolls is 4.1 while the roll diameter to foam plank thickness is 6.7 for the 12 inch rolls. As can be seen from the data presented in Table 4 and FIG. 2, higher applied strain and higher compressive set values may be attained at the larger roll diameter.

TABLE 3

| | Example 13 | Example 14 |
|---|---|---|
| Roll Diameter, inches | 12 | 4 |
| Blank Thickness, mm | 45.6 | 24.5 |
| Formed Surface | Cut/Low ρ | Cut/Low ρ |
| Roll Speed, fpm | 39 | 23 |
| Top Roll Temp, ° F. | 73 | 73 |
| Bottom Roll Temp, ° F. | 73 | 73 |

TABLE 4

| | |
|---|---|
| Example 13 | Example 14 |

| Applied | Compressive | Applied | Compressive |
|---|---|---|---|
| Strain | Set | Strain | Set |
| 3.00 | 1.59 | 10.71 | 7.95 |
| 9.93 | 7.43 | 37.63 | 23.05 |
| 9.75 | 7.31 | 37.23 | 25.12 |
| 21.93 | 15.44 | 57.00 | 39.39 |
| 22.73 | 16.67 | 59.08 | 40.35 |
| 34.71 | 24.01 | 80.91 | 63.18 |
| 35.11 | 25.63 | 79.11 | 61.31 |
| 42.09 | 30.59 | 69.75 | 51.77 |
| 41.12 | 29.45 | 70.23 | 52.10 |
| 48.53 | 33.80 | 89.37 | 72.05 |
| 47.85 | 32.99 | 89.23 | 71.25 |
| 61.33 | 38.97 | 88.41 | 75.93 |

Examples 15 to 22 are formed on the Chemsultants International laboratory bench top laminator (Model HL-1000) described hereinabove. The upper roll is fitted with a cylindrical two-piece aluminum shaping collar 50 having three sections 60, 70, and 80 each measuring 2 inches wide 62, 72, and 82, each section separated by a step change FIG. 4. The diameter 61 of the first section 60 is 5.2 inches, the diameter 71 of the second section 70 is 5.6 inches, and the diameter 81 of the third section 80 is 6 inches. The step change angle 43 between the upper roll 40 and the first section 60 is 90°, the step change angle 64 between the first section 60 and the second section 70 is 90°, the step change angle 74 between the second section 70 and the third section 80 is 90°, and the step change angle 44 between the third section 80 and the upper roll 40 is 90°.

The upper roll 40 and lower roll 90 are not heated, i.e., they are run at ambient temperature (about 23° C.). The gap 101 between the lower roll 90 and the first section of the shaping collar 60 is about 1.075 inch. The speed of the lower roll (e.g., the drive roll) 90 is set to about 20 feet per minute.

The foam blank specimens are prepared from the hereinabove described foam planks for Examples 15 to 22 are listed in Table 5.

TABLE 5

| Example | Foam Plank | Formed Surface |
|---|---|---|
| 15 | SCOREBOARD | As received/High ρ |
| 16 | SCOREBOARD | Cut/Low ρ |
| 17 | RTM-X | As received/High ρ |
| 18 | RTM-X | Cut/Low ρ |
| 19 | IMPAXX 300 | As received/High ρ |
| 20 | IMPAXX-300 | Cut/Low ρ |
| 21 | IMPAXX-500 | As received/High ρ |
| 22 | IMPAXX-500 | Cut/Low ρ |

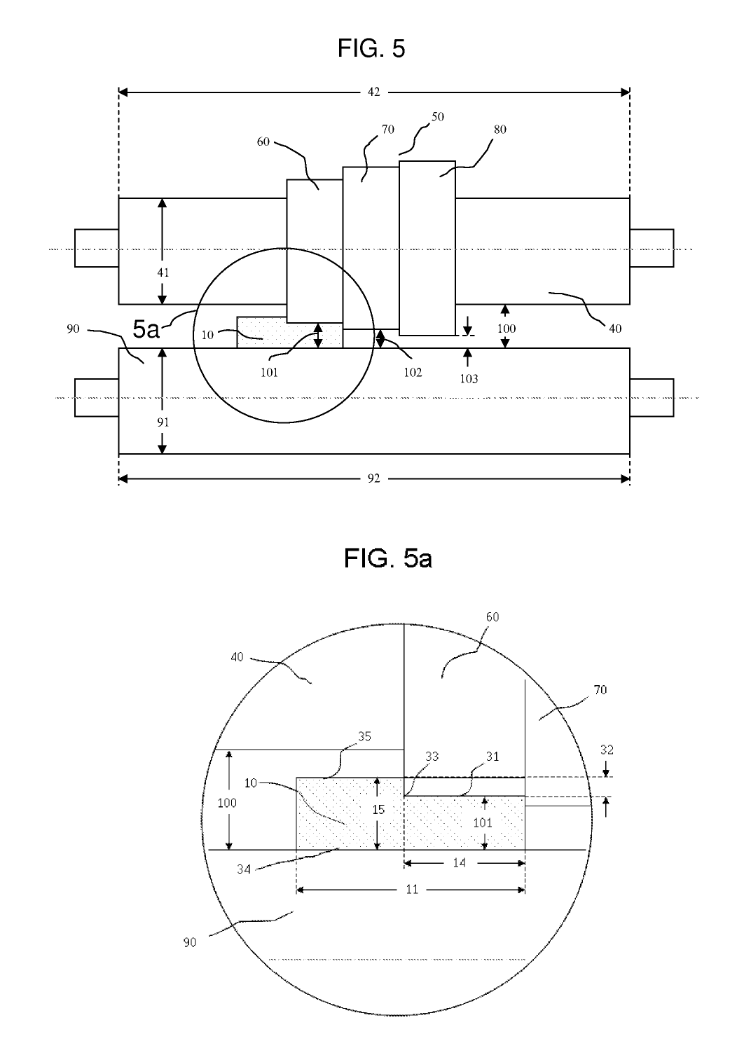

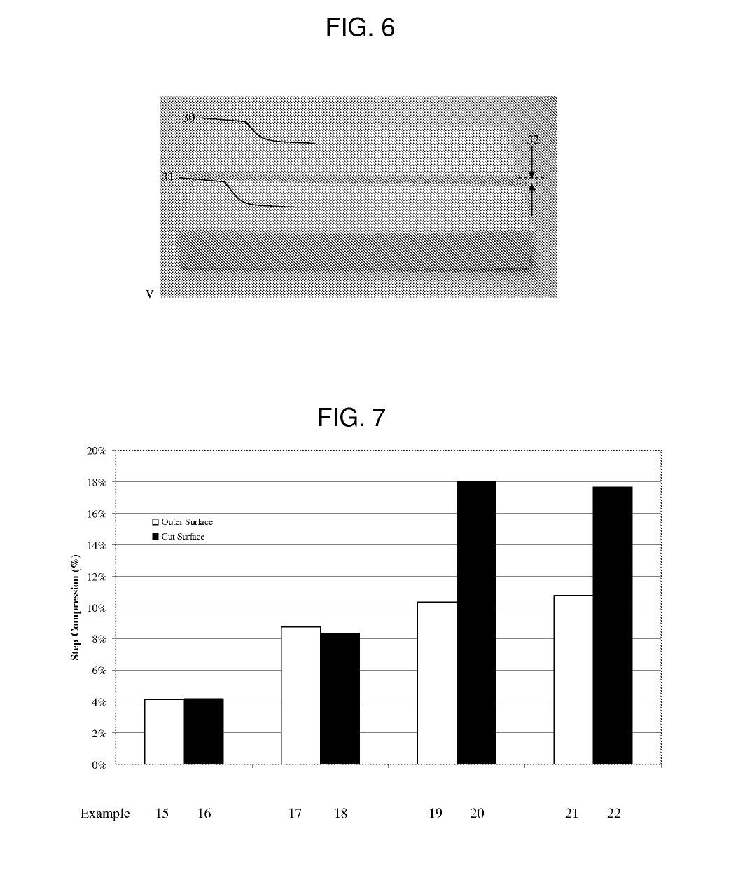

Prior to forming, the initial thickness, tₒ, of each foam sample is measured using a digital linear gauge. The foam samples are about 1.4 inches thick by 4 inches wide by 12 inches long. Three replicate samples for each example of foam are shaped and the reported compression set for each example is an average of the three samples. The pressing surface of each foam (e.g., the cut surface or as received surface as indicated) faces/contacts the shaping collar of the upper roll. The foam samples are passed through the shaping roll, or roll face, with a first half side of the sample aligned under the first section 60 and the other half, the second half side, of the sample aligned between the upper roll 40 and the lower roll 90. The second half side of the sample is not pressed/shaped (e.g., it is not contacted by the upper roll). The resulting step distance 32, the distance from the pressing surface 35 and the pressed surface 31 (FIG. 5a), is calculated about 24 hours after forming by measuring the final thickness of the compressed foam t_{f} and calculating the compression set as described hereinabove. The compression set for the shaped foamed articles is summarized in Table 6 and shown graphically in FIG. 7.

The data clearly shows that shaped foamed planks produced by the method of the present invention demonstrate improved compressive set.

TABLE 6

| Example | Compression Set, % |
|---|---|
| 15 | 4.1 |
| 16 | 4.2 |
| 17 | 8.7 |
| 18 | 8.3 |
| 19 | 10.3 |
| 20 | 18.0 |
| 21 | 10.7 |
| 22 | 17.6 |

1. A method to manufacture a shaped foam article comprising the steps of:
(i) extruding a polymer with a blowing agent to form a foam polymer plank, the plank having a thickness, a top surface, and a bottom surface in which said surfaces lie in the plane defined by the direction of extrusion and the width of the plank,
wherein the foam plank has
(i)(a) a vertical compressive balance equal to or greater than 0.4
and
(i)(b) one or more pressing surface
and
(ii) shaping the one or more pressing surface of the foam plank by a continuous process through one or more gap formed by one or more sets of rolls wherein each roll has a diameter and one or more roll has a roll face having a defined shape which when pressed into the foam plank provides a shaped foam article with the shape of the roll face.

2. The method of claim 1 wherein the pressing surface is created by the step of
(i)(b)(1) removing a layer of foam at least 1 millimeter thick from (A) the top surface, (B) the bottom surface, or (C) both the top and bottom surfaces
or
(i)(b)(2) cutting the foam plank between the top and the bottom surfaces creating two pressing surfaces opposite the top and bottom surfaces.

3. The method of claim 1 wherein the foam has a cell gas pressure equal to or less than 1 atmosphere.

4. The method of claim 1 wherein the foam plank is at ambient temperature during the shaping step.

5. The method of claim 1 wherein the rolls are heated independently to a temperature between 23° C. to 160° C.

6. The method of claim 1 wherein the roll diameters are individually at least four times the thickness of the foam plank.

7. The method of claim 1 wherein the polymer is a thermoplastic polymer selected from polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

8. The method of claim 7 wherein the thermoplastic polymer is polystyrene or styrene and acrylonitrile copolymer.

9. The method of claim 1 wherein the blowing agent is a chemical blowing agent, an inorganic gas, an organic blowing agent, or combinations thereof.

10. The method of claims 1 and 9 wherein the blowing agent is carbon dioxide.

11. A shaped foam article made by the method of claim 1.

12. The article of claim 11 is siding, an insulation sheathing, a decorative trim, a vinyl siding backing, an integrated radiant floor heating panel, a sandwich panel with non-planer faces, a composite panel, foot wear, a buoyancy part for boats or watercraft, a decoration product for a craft application, an energy absorption component in a helmet, an energy absorption component in a military application, an energy absorption component in an automotive article, or a cushion packaging article.
